(19) United States
(12) Patent Application Publication
(10) Pub. No.: US 2011/0147648 A1
(43) Pub. Date: Jun. 23, 2011

(54) NANOPARTICLE AGGREGATE AND METHOD OF MANUFACTURING THE SAME

(75) Inventor: Chil Seong AH, Daejeon (KR)

(73) Assignee: Electronics and Telecommunications Research Institute, Daejeon (KR)

(21) Appl. No.: 12/860,807

(22) Filed: Aug. 20, 2010

(30) Foreign Application Priority Data
Dec. 17, 2009 (KR) 10-2009-00125823

(51) Int. Cl. C09K 3/00

(52) U.S. Cl. 252/182.3; 252/182.11; 977/773

(57) ABSTRACT

Provided is a method of manufacturing a nanoparticle aggregate including: forming a micelle or reverse micelle structure including a nanoparticle aggregate therein, and forming a nanoparticle aggregate in which the number of nanoparticles is adjusted inside the micelle or reverse micelle structure by adjusting the size or shape of the inside of the formed micelle or reverse micelle structure. Therefore, a nanoparticle aggregate in which the number of nanoparticles is adjusted can be obtained through a simple process using a micelle or a reverse micelle. Also, a nanoparticle aggregate in which the number of nanoparticles is adjusted is provided.

### CROSS-REFERENCE TO RELATED APPLICATION

This application claims priority to and the benefit of Korean Patent Application No. 10-2009-0125823, filed Dec. 17, 2009, the disclosure of which is incorporated herein by reference in its entirety.

### BACKGROUND

1. Field of the Invention

The present invention relates to a nanoparticle aggregate and a method of manufacturing the same, and more particularly, to a nanoparticle aggregate in which the number of nanoparticles is adjusted and a method of manufacturing the same.

2. Discussion of Related Art

In terms of variety of color changes and surface plasmon light-absorption peaks over wide wavelengths of a nanoparticle aggregate in which the number and shape of nanoparticles are adjusted, manufacture of a nanoparticle (in particular, a metal nanoparticle) aggregate in a specific shape and size may be academically and industrially important.

The unique properties of the metal nanoparticle aggregate have great potential and numerous applications, and thus physicochemical properties according to the size of the metal nanoparticle aggregate have been drawing an increasing amount of attention.

However, only a few methods of manufacturing a nanoparticle aggregate having a desired size are known. Further, even known methods have required costly equipment or complicated processes for manufacturing.

### SUMMARY OF THE INVENTION

The present invention is directed to a method of manufacturing a micelle aggregate in which the number of nanoparticles is adjusted using a micelle and a nanoparticle aggregate manufactured using the same.

An aspect of the present invention provides a method of manufacturing a nanoparticle aggregate including: forming a micelle or reverse micelle structure including a nanoparticle aggregate therein; and forming a nanoparticle aggregate in which the number of nanoparticles is adjusted inside the micelle or reverse micelle structure by adjusting the size or shape of the inside of the formed micelle or reverse micelle structure.

The micelle structure may be formed by adding a small amount of organic solvent in which a micelle molecule and nanoparticles are dispersed to a large amount of polar material.

The micelle molecule may be formed of one selected from the group consisting of aerosol-OT/sodium bis(2-ethylhexyl) sulfosuccinate (AOT), cetylbenzyldimethylammonium chloride (CBAC), cetyltrimethylammonium chloride (CTAB), and t-octylphenoxypolyethoxyethanol (Triton X-100).

The size or shape of the inside of the micelle structure may vary according to at least one of a solution temperature, a micelle concentration, and a relative amount of a polar material and an organic solvent.

The number of nanoparticles may be adjusted according to at least one of a concentration of the micelle molecule, a concentration of the nanoparticles dispersed in the solution and an amount of solution in which the nanoparticles are dispersed.

The reverse micelle structure may be formed by adding a small amount of polar material in which a micelle molecule and nanoparticles are dispersed to a large amount of organic solvent.

The micelle molecule may be formed of one selected from the group consisting of aerosol-OT/sodium bis(2-ethylhexyl) sulfosuccinate (AOT), cetylbenzyldimethylammonium chloride (CBAC), cetyltrimethylammonium chloride (CTAB), and t-octylphenoxypolyethoxyethanol (Triton X-100).

The size or shape of the reverse micelle structure may vary according to at least one of a solution temperature, a micelle concentration, and a relative amount of a polar material and an organic solvent.

The number of nanoparticles may be adjusted according to at least one of a concentration of the micelle molecule, a concentration of the nanoparticles dispersed in the solution and an amount of solution in which the nanoparticles are dispersed.

The shape of the micelle or reverse micelle structure may be in a spherical or linear form.

The linear micelle or reverse micelle structure may be formed by further adding a micelle molecule after the spherical micelle or reverse micelle structure is formed.

The organic solvent may be formed of an organic molecule such as n-heptane.

The polar material may be formed of a molecule such as water exhibiting polarity.

A nanoparticle aggregate solution with various colors may be exhibited depending on the number of nanoparticles contained in the nanoparticle aggregate.

A surface plasmon light absorption of the nanoparticle aggregate solution may be exhibited in various ways depending on the number of nanoparticles contained in the nanoparticle aggregate.

Another aspect of the present invention provides a nanoparticle aggregate manufactured by the method of manufacturing a nanoparticle aggregate of the present invention.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1A is a diagram of a reverse micelle structure in various shapes formed using a micelle molecule, and FIG. 1B is a diagram illustrating a method of manufacturing a nanoparticle aggregate in which the number of nanoparticles is adjusted according to one exemplary embodiment;

FIG. 1C is a flowchart illustrating a method of manufacturing a nanoparticle aggregate in which the number of nanoparticles is adjusted according to one exemplary embodiment, and FIG. 1D is a flowchart illustrating a method of manufacturing a nanoparticle aggregate in which the number of nanoparticles is adjusted according to another exemplary embodiment;

FIG. 2 is a diagram of an example of a used micelle molecule according to one exemplary embodiment of the present invention;

FIG. 3 is a transmission electron microscopy (TEM) image of a nanoparticle aggregate in which the number of nanoparticles is adjusted according to one exemplary embodiment of the present invention; and

FIG. 4 shows an absorption spectrum of a solution including a nanoparticle aggregate in which the number of nanoparticles is adjusted according to one exemplary embodiment of the present invention.

### DETAILED DESCRIPTION OF EXEMPLARY EMBODIMENTS

The present invention will be described more fully hereinafter with reference to the accompanying drawings, in which exemplary embodiments of the invention are shown. This invention may, however, be embodied in different forms and should not be construed as limited to the embodiments set forth herein. In the following description of the present invention, a detailed description of known functions and components incorporated herein will be omitted when it may make the subject matter of the present invention rather unclear. In the drawings, like reference characters denote corresponding parts throughout the specification.

Where the term “comprising” is used throughout the specification, it is intended to denote inclusion of additional components rather than exclusion of any terms, steps or features unless specified to the contrary.

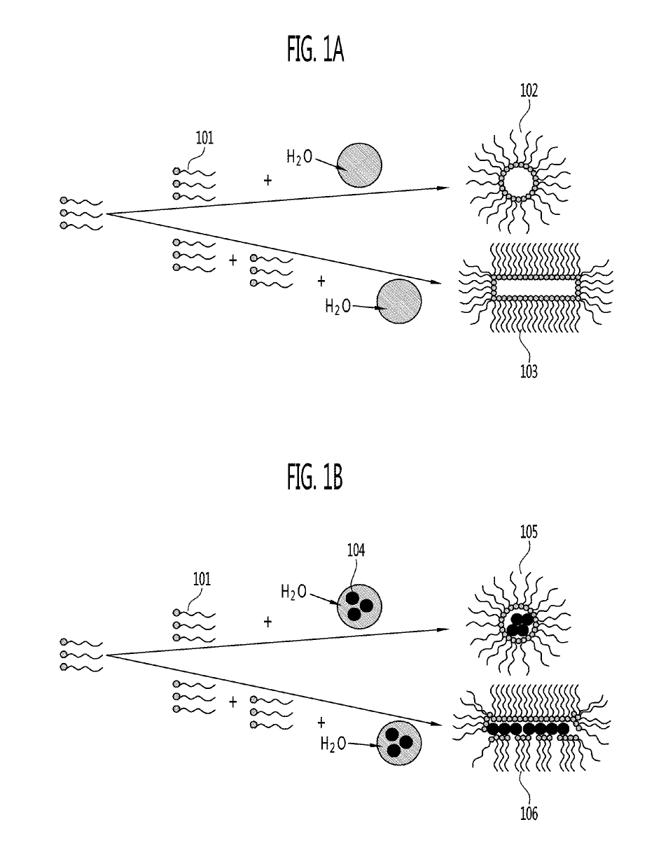

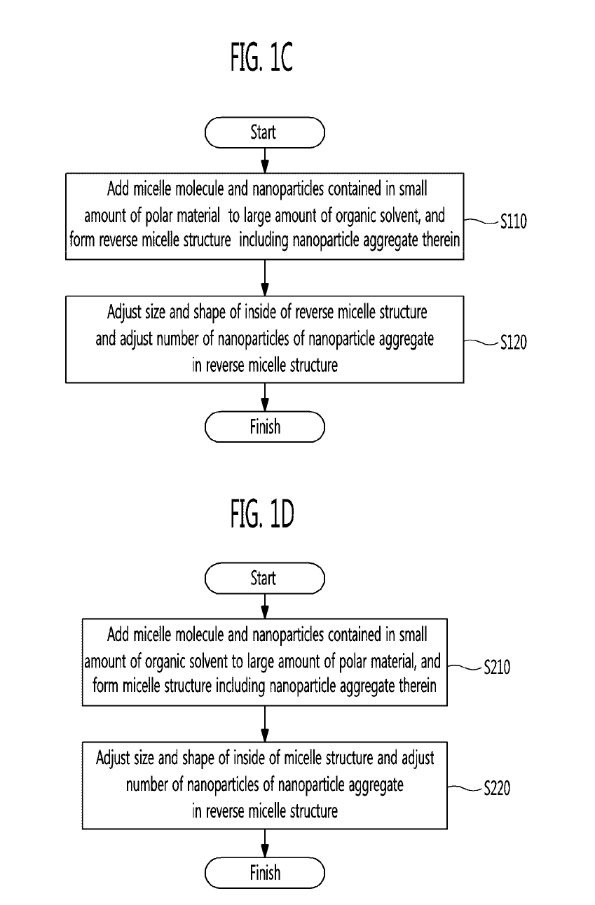

FIG. 1A is a diagram of a reverse micelle structure in various shapes formed using a micelle molecule, and FIG. 1B is a diagram illustrating a method of manufacturing a nanoparticle aggregate in which the number of nanoparticles is adjusted according to one exemplary embodiment.

FIG. 1C is a flowchart illustrating a method of manufacturing a nanoparticle aggregate in which the number of nanoparticles is adjusted according to one exemplary embodiment, and FIG. 1D is a flowchart illustrating a method of manufacturing a nanoparticle aggregate in which the number of nanoparticles is adjusted according to another exemplary embodiment.

Referring to FIG. 1A, a micelle molecule 101 is divided into a head group and a tail group. The head group exhibits hydrophilic properties and the tail group exhibits hydrophobic properties.

The micelle molecule 101 forms a micelle or reverse micelle structure depending on a used solvent.

When a small amount of water that is a polar material and the micelle molecule 101 are added to a large amount of organic solvent (not shown), a reverse micelle 102 (or a reverse micelle structure) in the shape of a sphere may be formed.

When the micelle molecule 101 is further added, a reverse micelle 103 (or a reverse micelle structure) in a linear form may be formed.

In the reverse micelle structure, the hydrophilic group of the micelle molecule 101 is inside the structure, and the hydrophobic group is on the outside of the structure. Further, the size and shape of the inside of the reverse micelle structure may be determined depending on at least one of a solution temperature, a micelle concentration, and a relative amount of water, which is a polar material, and an organic solvent.

That is, the reverse micelle, in which the size and shape are adjusted, may be filled with a polar solvent such as water.

While it is not illustrated, alternatively, when a small amount of organic solvent and the micelle molecule 101 are added to a large amount of water, which is a polar material, a micelle (or a micelle structure) in the shape of a sphere may be formed.

When the micelle molecule 101 is further added, a micelle (or a micelle structure) in a linear form may be formed.

In the micelle structure, a hydrophilic group of the micelle molecule 101 is on the outside of the structure, and a hydrophobic group is inside the structure, and like the reverse micelle structure, the size and shape of the inside of the micelle structure may be determined depending on at least one of a solution temperature, a micelle concentration, and a relative amount of water, which is a polar material, and an organic solvent.

That is, the micelle, in which the size and shape are adjusted, may be filled with an organic solvent.

Referring to FIGS. 1B, 1C and 1D, a nanoparticle aggregate in which the number of nanoparticles is adjusted may be manufactured using such characteristics of the micelle or reverse micelle.

In FIGS. 1B and 1C, a method of manufacturing a nanoparticle aggregate using a reverse micelle structure will be described, and in FIG. 1D, a method of manufacturing a nanoparticle aggregate using a micelle structure will be described.

As an exemplary embodiment of the present invention, when the micelle molecule 101 and nanoparticles contained in a small amount of water, a polar material, are added to a large amount of organic solvent, a nanoparticle aggregate having a spherical reverse micelle 105 (or reverse micelle structure) that has nanoparticles inside is formed (S110).

The nanoparticles are dispersed (i.e., aggregated) in a solvent filling the micelle, or in this case, water, which is a polar material.

When more micelle molecules 101 than the amount required for forming the reverse micelle in a spherical shape are added, a nanoparticle aggregate having a reverse micelle 106 (or a reverse micelle structure) in a linear shape is formed.

The number of nanoparticles is determined depending on the size of the inside of the reverse micelle. That is, the number of nanoparticles may be proportional to the size of the inside of the reverse micelle (S120).

According to another exemplary embodiment of the present invention, when a micelle molecule 101 and nanoparticles 104 contained in a small amount of organic solvent are added to a large amount of water, which is a polar material, a nanoparticle aggregate having a spherical micelle (or micelle structure) (not shown) that has nanoparticles inside is formed (S210).

The nanoparticles are dispersed (i.e., aggregated) in a solvent with which the inside of the micelle is filled, and in this case, an organic solvent.

When more micelle molecules 101 than the amount required for forming the micelle in a spherical shape and nanoparticles 104 are added, a nanoparticle aggregate having a micelle (or a micelle structure) (not shown) in a linear shape is formed.

The number of nanoparticles is determined depending on the size of the inside of the micelle. That is, the number of nanoparticles may be proportional to the size of the inside of the micelle (S220).

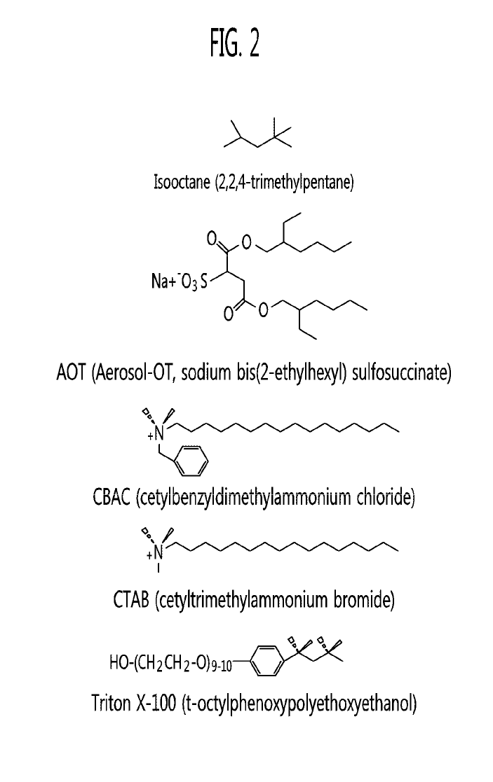

FIG. 2 is a diagram of an example of a used micelle molecule according to one exemplary embodiment of the present invention.

Referring to FIG. 2, a micelle molecule used for manufacturing a nanoparticle aggregate according to one exemplary embodiment of the present invention includes aerosol-OT/sodium bis(2-ethylhexyl) sulfosuccinate (AOT), cetylbenzyldimethylammonium chloride (CBAC), cetyltrimethylammonium chloride (CTAB), t-octylphenoxypolyethoxyethanol (Triton X-100), etc.

However, this is merely an example, and a micelle molecule used in the exemplary embodiment of the present invention is not limited thereto.

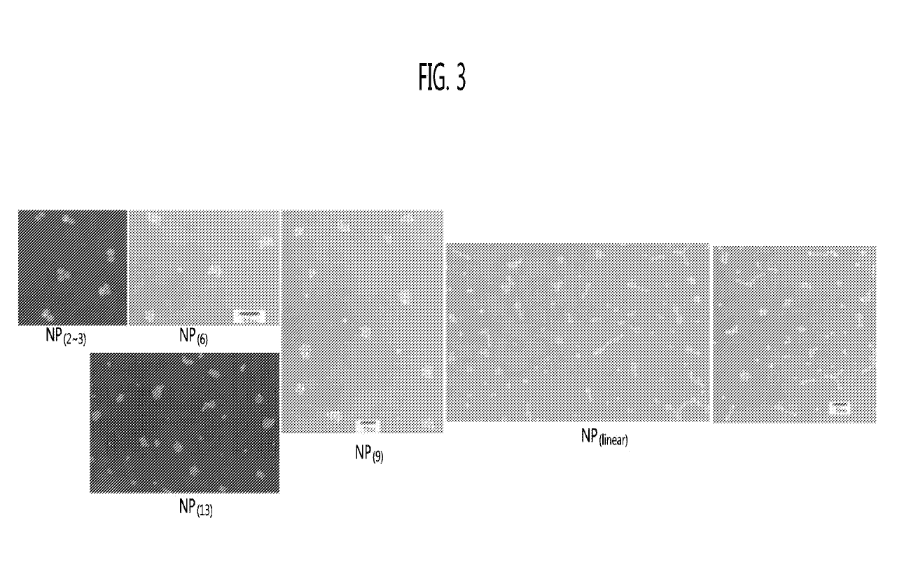

FIG. 3 is a TEM image of a nanoparticle aggregate in which the number of nanoparticles is adjusted according to the exemplary embodiment of the present invention.

The transmission electron microscopy (TEM) image of FIG. 3 illustrates an aggregate in which an aqueous solution containing gold nanoparticles having a diameter of 13 nm and an AOT micelle molecule are added to an organic solvent, so that the number of nanoparticles is adjusted.

Referring to FIG. 3, nanoparticle aggregates consisting of 2, 3, 6, 9, and 13 gold nanoparticles (referred to as NP₍₂₋₃₎, NP₍₆₎, NP₍₉₎, and NP₍₁₃₎, respectively) are shown, and a nanoparticle aggregate (NP₍ₗᵢₙₑₐᵣ₎) in a linear form is shown as well.

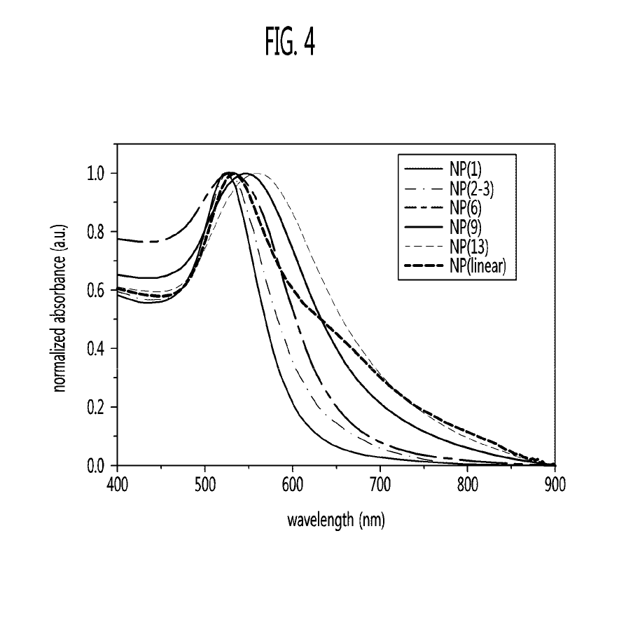

FIG. 4 shows an absorption spectrum of a solution including a nanoparticle aggregate in which the number of nanoparticles is adjusted according to one exemplary embodiment of the present invention.

NP(1) denotes a light-absorption spectrum of a gold nanoparticle dispersed in an aqueous solution.

Referring to FIG. 4, it is observed that as the number of nanoparticles contained in a nanoparticle aggregate is increased, the maximum absorption wavelength shifts towards a long wavelength.

A nanoparticle aggregate solution with various colors may be exhibited depending on the number of nanoparticles contained in the nanoparticle aggregate according to the exemplary embodiment of the present invention.

Also, surface plasmon light absorption of the nanoparticle aggregate solution may be exhibited in various ways depending on the number of nanoparticles contained in the nanoparticle aggregate according to the exemplary embodiment of the present invention.

The number of nanoparticles in a nanoparticle aggregate may be determined by at least one of a micelle concentration, a concentration of the gold nanoparticles dispersed in the aqueous solution and an amount of the aqueous solution in which the gold nanoparticles are dispersed.

In FIGS. 3 and 4, 5 mL of n-heptane was used as the organic solvent, the concentration of AOT used as the micelle molecule was 10⁻⁵ M, and the concentration of the gold nanoparticles was 20 μM.

The amount of 20 μM gold nanoparticle aqueous solution with respect to NP₍₂₋₃₎, NP₍₆₎, NP₍₉₎, and NP₍₁₃₎ was 8 μl, 4 μl, 2 μl and 1 μl respectively. Further, the concentration of AOT with respect to NP₍ₗᵢₙₑₐᵣ₎ was 10⁻³ M, and 8 μl of a 20 μM gold nanoparticle aqueous solution was added.

In a method of manufacturing a nanoparticle aggregate according to one exemplary embodiment of the present invention, a nanoparticle aggregate in which the number of nanoparticles is adjusted can be obtained using merely a micelle or a reverse micelle without costly equipment or complicated processes for manufacturing.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of manufacturing a nanoparticle aggregate, comprising:
forming a micelle or reverse micelle structure including a nanoparticle aggregate therein; and
forming a nanoparticle aggregate in which the number of nanoparticles is adjusted inside the micelle or reverse micelle structure by adjusting the size or shape of the inside of the formed micelle or reverse micelle structure.

2. The method of claim 1, wherein the micelle structure is formed by adding a small amount of organic solvent in which a micelle molecule and nanoparticles are dispersed to a large amount of a polar material.

3. The method of claim 2, wherein the micelle molecule is formed of one selected from the group consisting of aerosol-OT/sodium bis(2-ethylhexyl) sulfosuccinate (AOT), cetylbenzyldimethylammonium chloride (CBAC), cetyltrimethylammonium chloride (CTAB), and t-octylphenoxypolyethoxyethanol (Triton X-100).

4. The method of claim 2, wherein the size or shape of the inside of the micelle structure varies according to at least one of a solution temperature, a micelle concentration, and a relative amount of a polar material and an organic solvent.

5. The method of claim 2, wherein the number of nanoparticles is adjusted according to at least one of a concentration of the micelle molecule, a concentration of the nanoparticles dispersed in the solution and an amount of solution in which the nanoparticles are dispersed.

6. The method of claim 1, wherein the reverse micelle structure is formed by adding a small amount of a polar material in which a micelle molecule and nanoparticles are dispersed to a large amount of organic solvent.

7. The method of claim 6, wherein the micelle molecule is formed of one selected from the group consisting of aerosol-OT/sodium bis(2-ethylhexyl) sulfosuccinate (AOT), cetylbenzyldimethylammonium chloride (CBAC), cetyltrimethylammonium chloride (CTAB), and t-octylphenoxypolyethoxyethanol (Triton X-100).

8. The method of claim 6, wherein the size or shape of the reverse micelle structure varies according to at least one of a solution temperature, a micelle concentration, and a relative amount of a polar material and an organic solvent.

9. The method of claim 6, wherein the number of nanoparticles is adjusted according to at least one of a concentration of the micelle molecule, a concentration of the nanoparticles dispersed in the solution and an amount of solution in which the nanoparticles are dispersed.

10. The method of claim 1, wherein the micelle or reverse micelle structure has a spherical or linear shape.

11. The method of claim 10, wherein the linear micelle or reverse micelle structure is formed by further adding a micelle molecule after the spherical micelle or reverse micelle structure is formed.

12. The method of claim 2, wherein the organic solvent is formed of an organic molecule such as n-heptane.

13. The method of claim 2, wherein the polar material is formed of a molecule exhibiting a polarity such as water.

14. The method of claim 2, wherein a nanoparticle aggregate solution with various colors is exhibited depending on the number of nanoparticles contained in the nanoparticle aggregate.

15. The method of claim 2, wherein a surface plasmon light absorption of a nanoparticle aggregate solution is exhibited in various ways depending on the number of nanoparticles contained in the nanoparticle aggregate.

16. The method of claim 6, wherein the organic solvent is formed of an organic molecule such as n-heptane.

17. The method of claim 6, wherein the polar material is formed of a molecule exhibiting a polarity such as water.

18. The method of claim 6, wherein a nanoparticle aggregate solution with various colors is exhibited depending on the number of nanoparticles contained in the nanoparticle aggregate.

19. The method of claim 6, wherein a surface plasmon light absorption of a nanoparticle aggregate solution is exhibited in various ways depending on the number of nanoparticles contained in the nanoparticle aggregate.

20. A nanoparticle aggregate manufactured by the method of manufacturing a nanoparticle aggregate of claim 1.
